(19) United States
(12) Patent Application Publication
(10) Pub. No.: US 2008/0112782 A1
(43) Pub. Date: May 15, 2008

(54) Display Crates, Trays and Boxes

(75) Inventors: John Leahy, Victoria (AU); Boris Dobra, Victoria (AU)

Correspondence Address: MERCHANT & GOULD PC, P.O. BOX 2903, MINNEAPOLIS, MN, 55402-0903, US

(73) Assignee: CHECKMATE INTERNATIONAL PTY LTD., Huntingdale (AU)

(21) Appl. No.: 11/597,311

(22) PCT Filed: May 23, 2005
(86) PCT No.: PCT/AU05/00733

§ 371 Date: Aug. 7, 2007

(30) Foreign Application Priority Data
May 21, 2004 (AU) 2004902713
Apr. 14, 2005 (AU) 2005901866

(51) Int. Cl. B65G 1/00

(52) U.S. Cl. 414/281

(57) ABSTRACT

A combined transporting and merchandising display system includes a stacked array of packaging crates. Each crate has one or more openings in the front wall and/or rear wall for access to and removal of product from the crate. Inter-engaging flutes and recesses on respective upper and lower crates secure the crates together in a nested relationship. A series of fine ribs is arranged on the top surface of the base of each crate to reduce friction between the product and the base so as to allow for gravity feeding of the product to the front of the crate is tilted forwards. The bottom crate is engageable with a tiltable top surface on a trolley (not shown) such that the stacked array of crates can be wheeled about. The product is preferably bottles or cartons of milk.

### FIELD OF THE INVENTION

This invention relates to the logistics of packing, distribution and merchandising of products, and refers particularly, though not exclusively, to a crate system to transport and merchandise products in retail stores.

### BACKGROUND OF THE INVENTION

Typically products are transported to retail stores in crates, trays or cardboard boxes. They provide an effective means by which to transport large quantities of product and also protect the product while in transit. At the store the contents are removed from the container, placed on a trolley, pushed to the point of sale and placed one at a time on the shelf. The packaging is usually destroyed or recycled. As product is sold the older stock is pulled forward and new stock placed behind the older product.

Maintaining fill and faced up shelves requires considerable time and is very labour intensive. More recently shelves have been fitted with dividers and or a slip surface so shelves can be angled to gravity feed. This reduces the time taken to manage product as stock does not need to be pulled forward as it is sold and can be rotated when new product is loaded at the rear. This reduced the time taken to merchandise products in the store but has the following disadvantages. In particular, the removal of product one by one from the packaging, placement on a trolley for transport to the shelf and subsequent loading onto the shelf remains a labour intensive task. It would be more desirable if the process of transport, unpacking, shelf filling and shelf maintenance could be streamlined and made less labour intensive. It would be desirable if the logistics involved a packaging and transport system in which product was delivered in a transportable manner that eliminated all the labour required to make the product ready for sale. A system in which the product would be pushed direct to the point of sale, shelf ready for sale and able to gravity feed to avoid constant facing up.

By way of example, though not exclusively, milk is brought to stores in crates. They provide an effective means by which to transport high volumes of milk and also protect the product while in transit. Large numbers of crates can be stacked on pallets for efficient handling by forklifts and pallet jacks. On arrival at the store the milk cartons or bottles are taken one at a time out of the crates and placed on dairy case shelves. Empty crates are stacked on top of each other but do not nest so they consume valuable space in the retail store. Later they are collected by the supplier and cleaned on return to the factory.

As milk is sold new stock is loaded onto the shelf. The older dated stock is pulled forward so milk does not become outdated. Handling milk in this manner is labour intensive and costly. It is also difficult to keep the shelves clean. It would be desirable if the logistics involved a transport and merchandising system which transported the milk to the store in shelf ready packaging that could be placed straight on the shelf ready to be gravity feed to the front of the shelf as forward product is purchased.

One improvement was to place the loaded milk crates on a mobile platform or dolly in front of cool room doors. Customers lifted the milk directly out of the crates. However, this system poorly presented the milk. It was difficult to remove the larger bottles of milk from the crates and stock rotation was a problem

More recently some retailers have replaced crates on dollies with milk rear loaded into gravity feed shelves in milk racks or gravity feed shelves in mobile trolleys. The shelves having dividers with slip surfaces to separate and gravity feed the milk. This system has superior milk presentation, better customer identification and selection and improved stock rotation of the milk. However, this system requires each milk pack to be lifted by hand out of the crate and individually loaded into the back of the shelf, which is also labour intensive. As well, dividers become soiled and are difficult to clean.

Accordingly, it is an object of this invention in a first aspect to address these and other problems associated with the prior art.

### DESCRIPTION OF THE INVENTION

A first inventive concept resides in a recognition that handling costs and retail merchandising are advantageously improved by adding a slip surface of fine ribs and/or dividers to the base of a crate, tray or cardboard carton or other similar packing device. This packaging with a high slip surface and/or dividers can be automatically filled with products and the crate, tray or carton placed on a mobile dolly for transport to the store. At the store the mobile dolly could be pushed to the point of sale and the dolly platform angled to gravity feed product to the front of the crate, tray or cardboard carton. Customers purchasing product would remove it directly through the front of the crate, tray or carton and the remaining product would gravity feed toward the front of the crate, tray or cardboard carton. Product would remain faced up at all times. This would eliminate the need for the product to be placed on the shelf and to be constantly pulled forward as stock is sold. With this system, the contents would never be touched by human hand. Ideally the crates, trays and cardboard cartons or other similar merchandising devices, as well as the dollies, would be nested for efficient storage after the product is sold and returned to the manufacturer for cleaning and re-use if this is required.

Accordingly, in the first aspect, the invention provides for a crate, tray, carton or other similar merchandising device, for transporting and merchandising products. Preferably, the front and rear face or ends are open, however, it could have only one open end. The front opening is spaced apart from the rear opening and connected to the front member by a base member and two spaced apart side members.

Preferably, the base member has fine nibs to reduce the co-efficient of friction and/or one or more vertical webs to divide product, which run parallel to each other from the open front face or end to the rear face or end.

Preferably, the fine ribs producing the slip surface and/or dividers on the base member are an integral part of the base or could be inserts placed into slots in the base.

Preferably, the front and rear opening is dissected by a horizontal member to contain product in the crate, tray or carton whilst in transit and when the product is angled to gravity feed. This horizontal member being about one third the vertical height of the spaced apart sides with the space below remaining as open in structure as possible such that:
a) the label of the milk of other duct can be seen from outside the crate.
b) the product does not fall out when angled to gravity feed
c) the milk or similar product can be removed easily from the crate by the purchaser

Preferably, the spaced apart sides are tapered such that the spaced apart sides are wider at the top than at the bottom. The spaced apart sides having alternative vertical tapered recesses and flutes so that the opposing flute of one above crate, tray or carton can engage the recess of a second below crate, tray or carton when in the adjacent position. However, when a second above crate, tray or carton is stepped back slightly the bottom of a flute engages the enclosed top of a below flute to stack the crate, tray or carton

Preferably, the top remains open for easy filling

Preferably, the crate, tray or carton is of one piece but could be of several sections.

A second inventive concept resides in a recognition that handling and merchandising costs are advantageously improved if the crates, trays and cartons could be transported on a dolly that could be easily angled to gravity feed product on arrival at the store.

Accordingly, in the second aspect, the invention provides for a dolly with one or more spaced apart horizontal members that are pivoted to a dolly so that stacked crates can be angled to gravity feed.

Preferably, the pivot point is slightly to the rear of the centroid point of the stacked above crates, trays or cartons so that the merchandised crates, trays and cartons can be angled with minimum effort.

Preferably, the dolly has a foot operated locking attachment at the front of the first spaced apart member to lock the second spaced apart member in the horizontal position when in transport and release the above spaced apart member to angle the mobile merchandiser for gravity feeding.

Preferably, the first spaced apart horizontal member has two rear spaced apart vertical members to prevent the second spaced apart horizontal member or other above spaced apart members from angling the load backward.

Preferably, the first spaced apart horizontal member has two fixed castors in adjacent comers at the front and two swivel castors in adjacent corners at the rear.

### DESCRIPTION OF DRAWINGS

Preferred embodiments of a mobile display merchandiser incorporating the principal features of the present invention will now be described with reference to the accompanying illustrative drawings, in which:

FIG. 1 is a front perspective view of a crate with fine ribs according to the present invention

FIG. 2 is a top, side and front plan view of a crate according to the present invention.

FIG. 3 is side and front plan view of crates in the stacked position.

FIG. 4 is a front perspective view of four stacked crates.

FIG. 5 is a front and side plan view of four nested crates.

FIG. 6 is a front perspective view of four nested crates.

FIG. 7 is a front perspective view of a dolly in the horizontal position according to the present invention.

FIG. 8 is a front perspective view of a dolly in the angled position.

FIG. 9 is a side and front plan view of four crates stacked on a dolly in the horizontal position.

FIG. 10 is a side plan view of four crates on a dolly in the angled position for gravity feeding

FIG. 11 is a tray with fine ribs and a divider according to the present invention

FIG. 12 is a front perspective view of a cardboard carton with fine ribs and dividers.

FIG. 13 is a side view of a cardboard carton on an angled trolley according to the present invention

### DESCRIPTION OF EMBODIMENTS

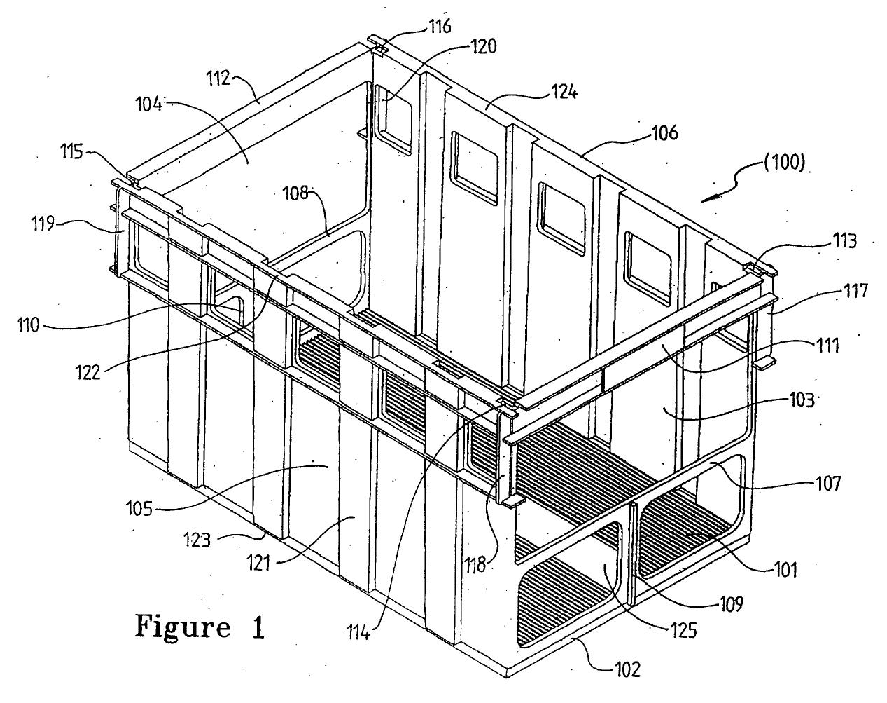

FIG. 1, illustrates a self-feeding milk crate (100) according to an embodiment of the invention. The crate has fine nibs 101 and a divider 125 on the base 102 running parallel from front face 103 to the to rear face 104. The crate has an open front face 103 and/or rear face 104 and two spaced apart sides 105 and 106. The width at the top of spaced apart side 105 and 106 is wider than the bottom of spaced apart sides 105 and 106.

The open front 103 and/or rear 104 is dissected by a horizontal front member 107 and horizontal rear member 108 with vertical support 109 and 110. The open font has a top front horizontal support 111 and top rear horizontal support 112, with spaced apart corner recesses 113,114,115,116 to lock an above stacked crate. The top of each corner has vertical protrusions 117,118,119 and 120 to guide the crate when placed end down on a conveyor belt.

Elongated, tapered vertical flutes 121 nest into tapered vertical recesses 122 of a below adjacent crate.

The flat webs 123 at the base off flutes 121 stack on horizontal supports 124 when an above crate is stacked in a stepped back position.

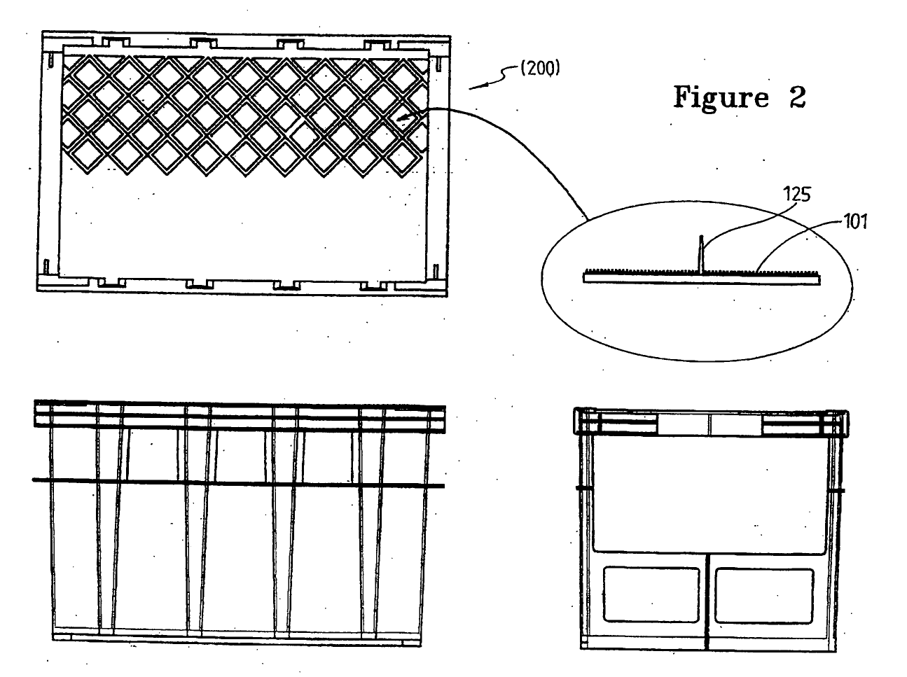

FIG. 2, (200) illustrates a crate with fine ribs 101 and a divider 125

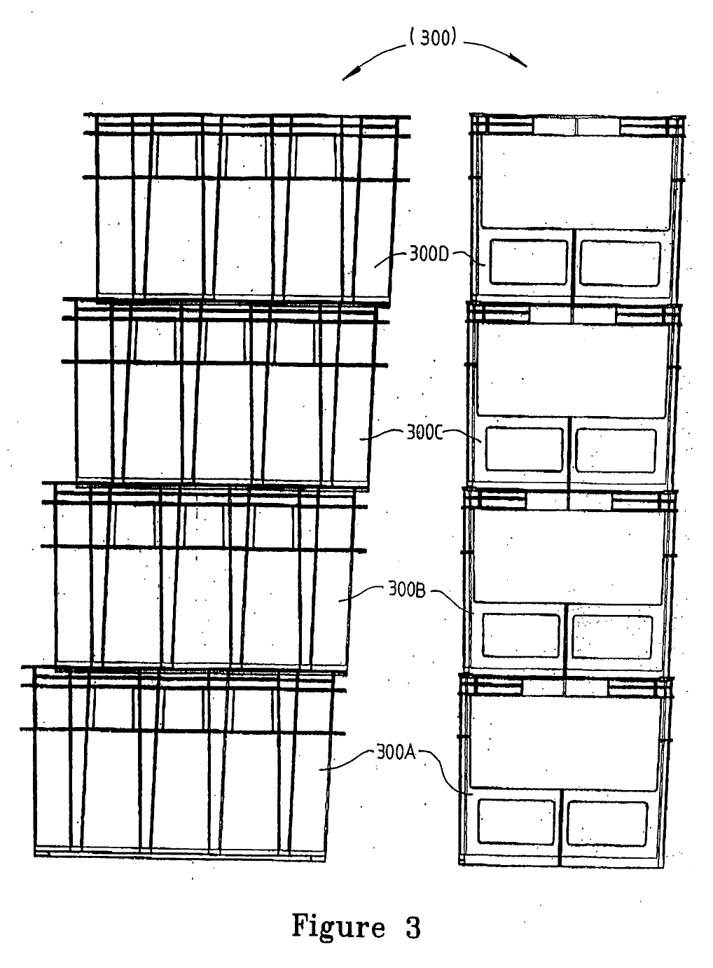

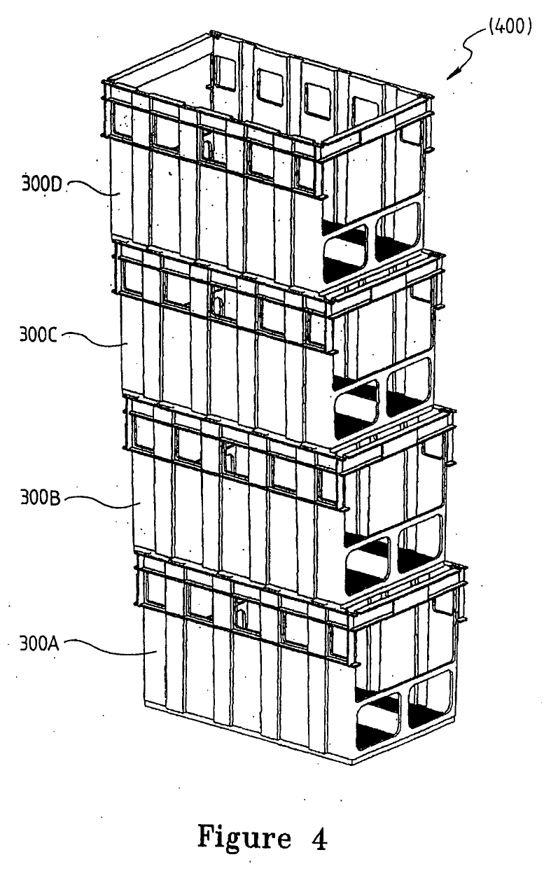

FIGS. 3 and 4, shows four crates 300A, 300B, 300C and 300D stacked on top of each other it which 300B is stepped back from 300A, 300C is stepped back from 300B and 300D is stepped back from 300C.

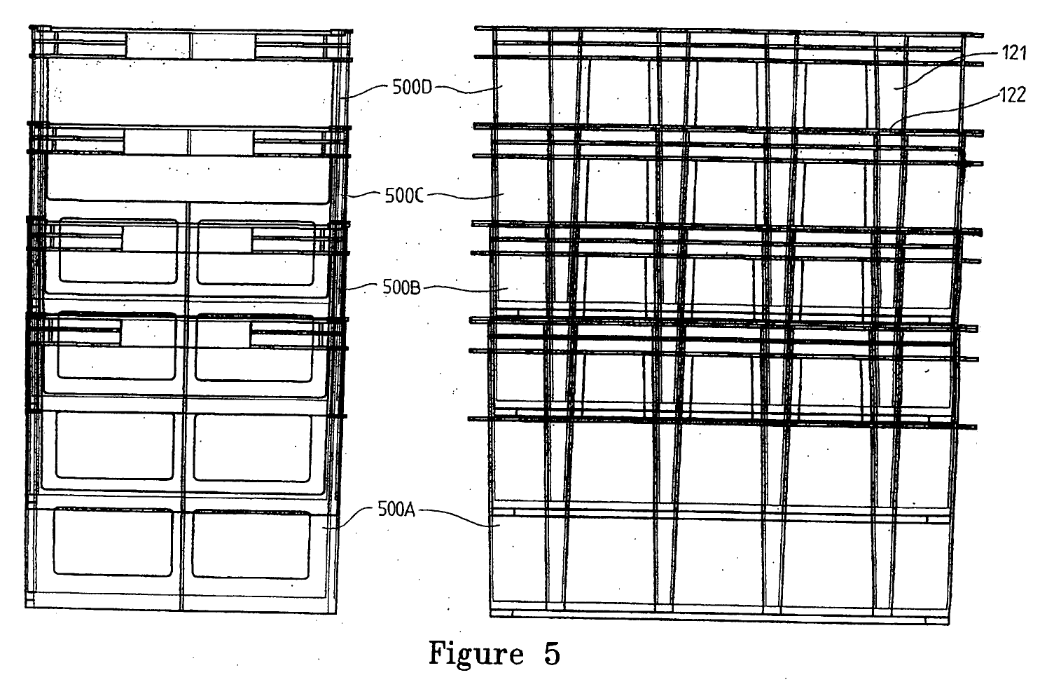

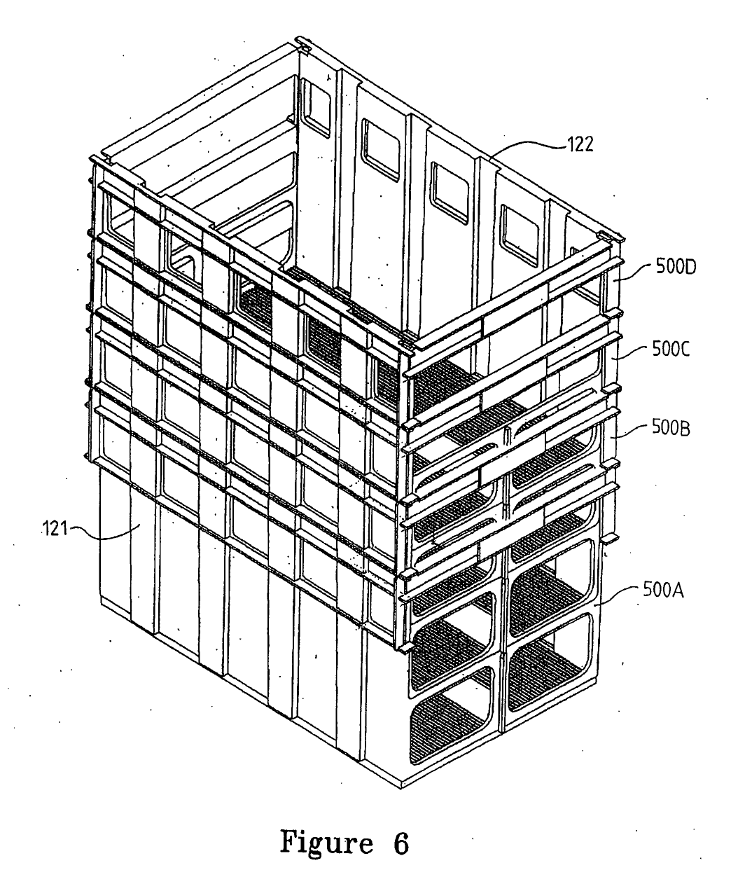

FIG. 5 and 6, illustrates fur self-feeding crates in the nesting position in which 500B nests into 500A, 500C nests into 500B and 500D into 500C by engaging flutes 121 in recess 122

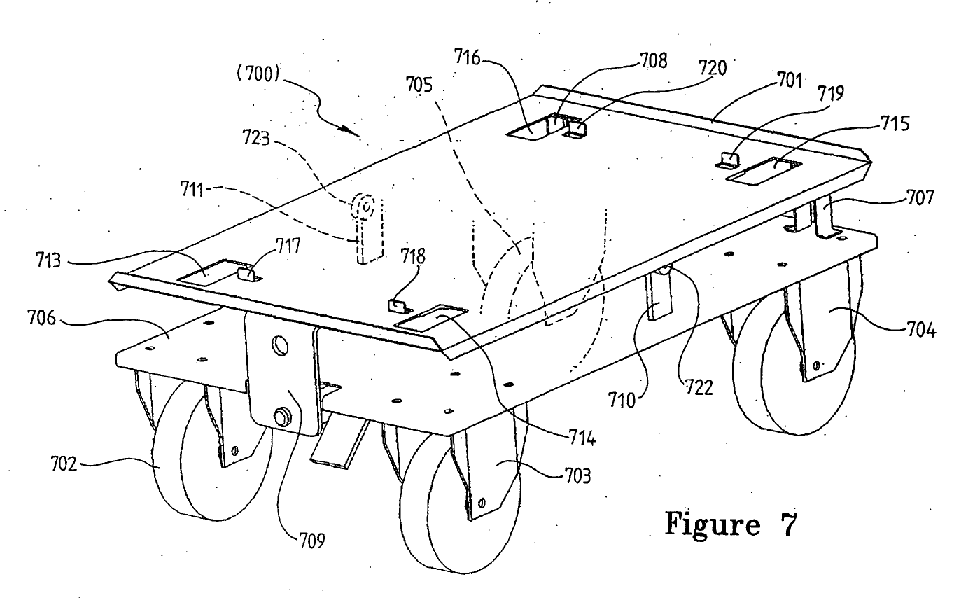

FIG. 7, is a dolly (700) with pivoting second spaced apart member 701. The dolly has two fixed castor wheels 702 and 703 at the front and two swivel castor wheels 704 and 705 at the rear, attached to the first spaced apart horizontal member 706. The first spaced apart member 706 has two rear vertical spaced apart supports 707 and 708 to prevent the second spaced apart member falling backward when the lock 709 is released.

The dolly has two vertical spaced apart extensions 710 and 711 positioned slightly to the rear of the centroid point of above stacked crates on the first spaced apart horizontal member 506 with a pivot 712 and 713 connecting the first horizontal spaced apart member 706 to the second spaced apart horizontal member 701.

The second horizontal spaced apart member 701 has four corner recess sections 713, 714, 715 and 716 to engage the wheels 702, 703, 704 and 705 when dollies are stacked on each other and four upright protrusions 717, 718, 719 and 720 to engage the crate base 102.

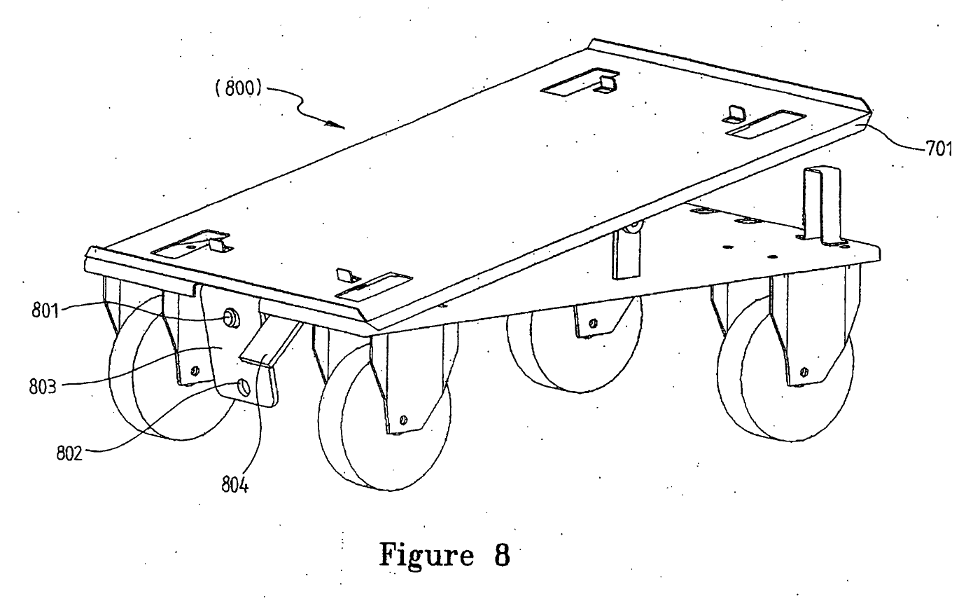

FIG. 8, illustrates the dolly in the angled position (800) when the second spaced apart horizontal member 701 is angled to gravity feed when plunger pin 801 is released from the slot 802 in the front vertical extension 803 attached to the second spaced apart horizontal member 701 when pedal extension 804 is pressed backward depressing coiled spring 901 captured in rectangular frame 902.

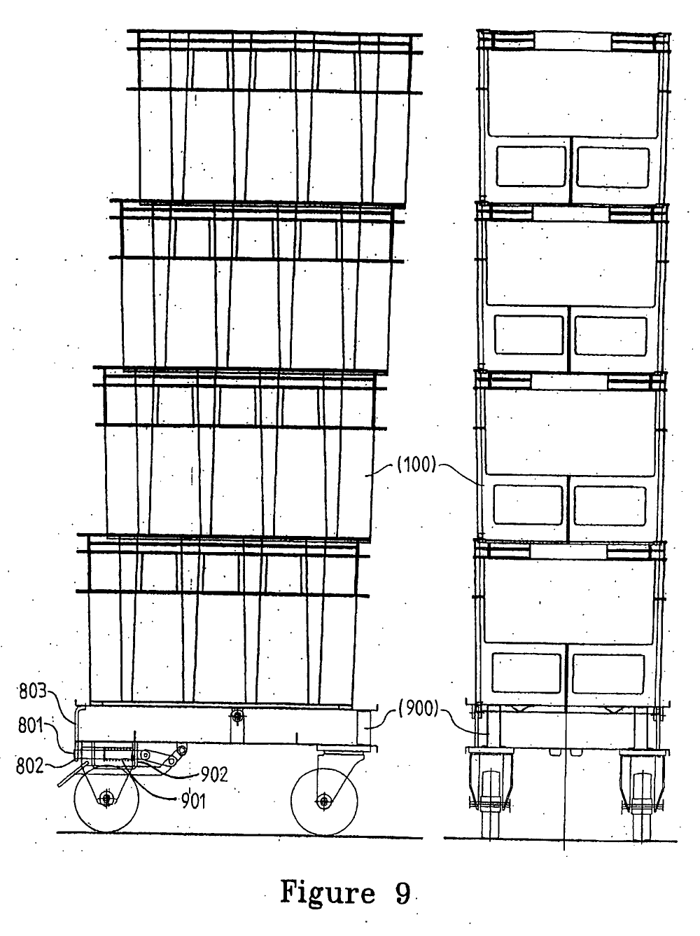

FIG. 9, illustrates a dolly (900) stacked with crates (100) in the stepped back position when pin 801 is engaged in the slot 802 in the front vertical extension 803.

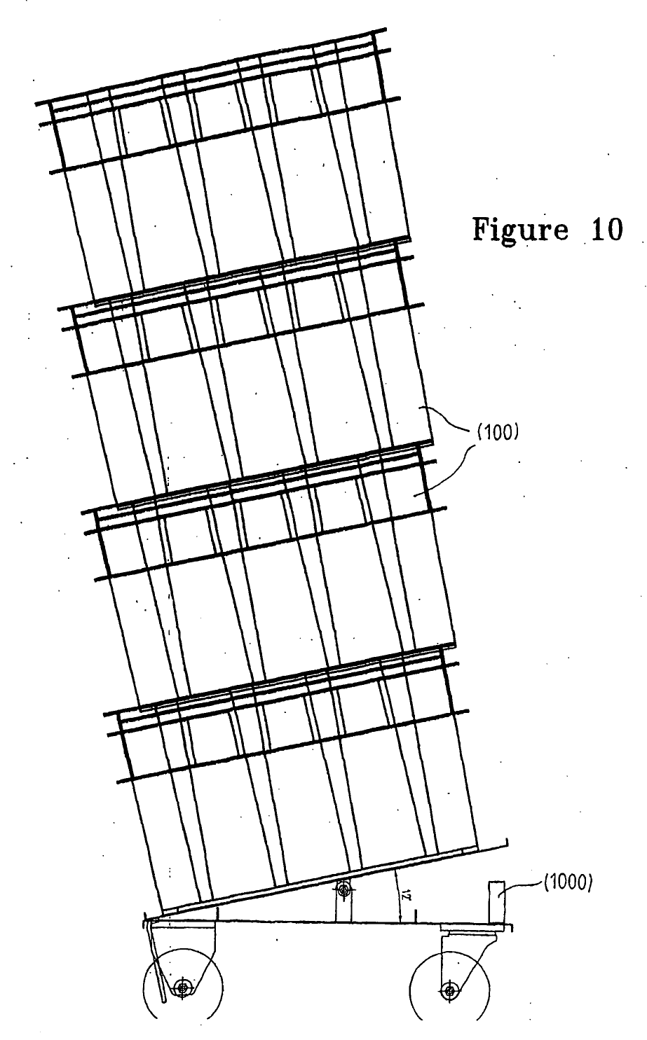

FIG. 10, illustrates four crates (100) stacked in the angled gravity feed position when pin 801 is released from the slot 802 in the front vertical extension 803

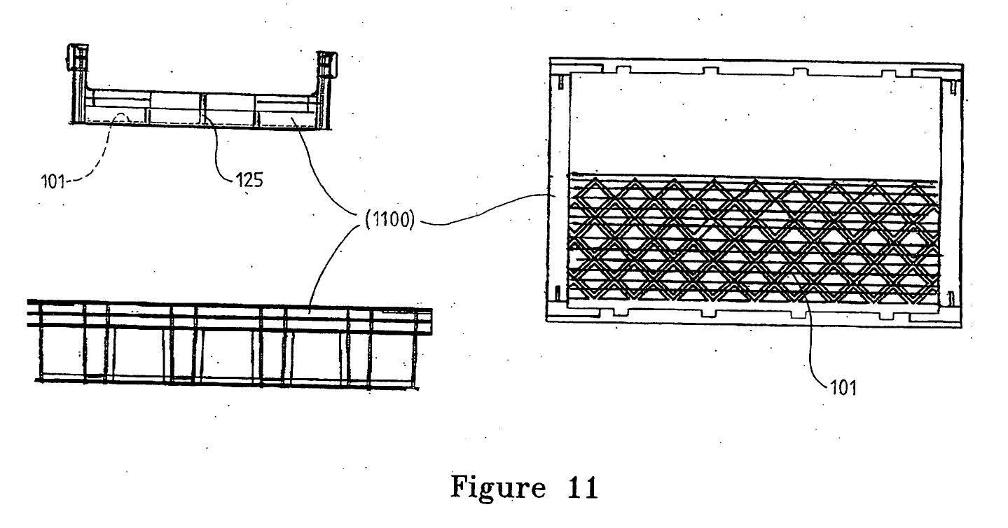

FIG. 11, is a tray (100) with fine ribs 101 and a divider 125

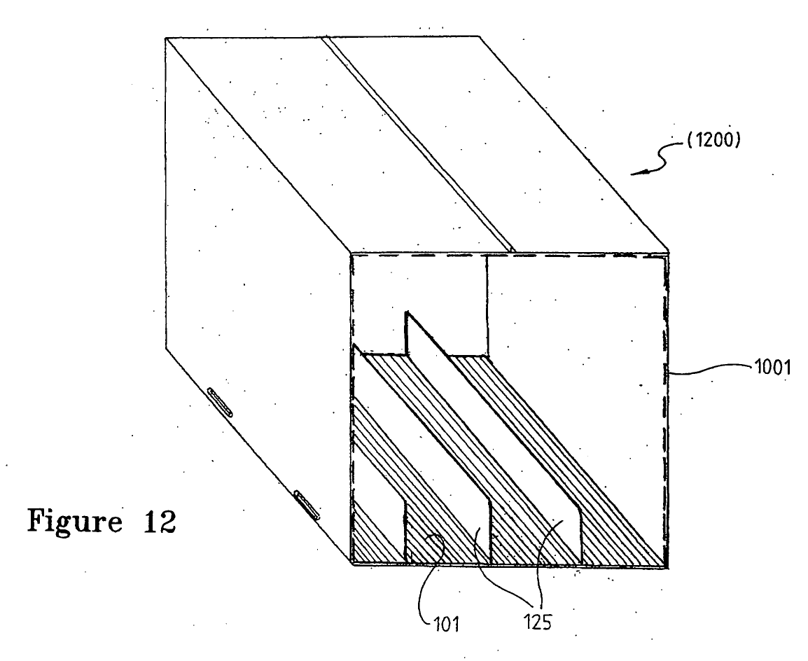

FIG. 12, is a cardboard carton (1200) with fine ribs 101 and a dividers 125 with tear off open end 1001

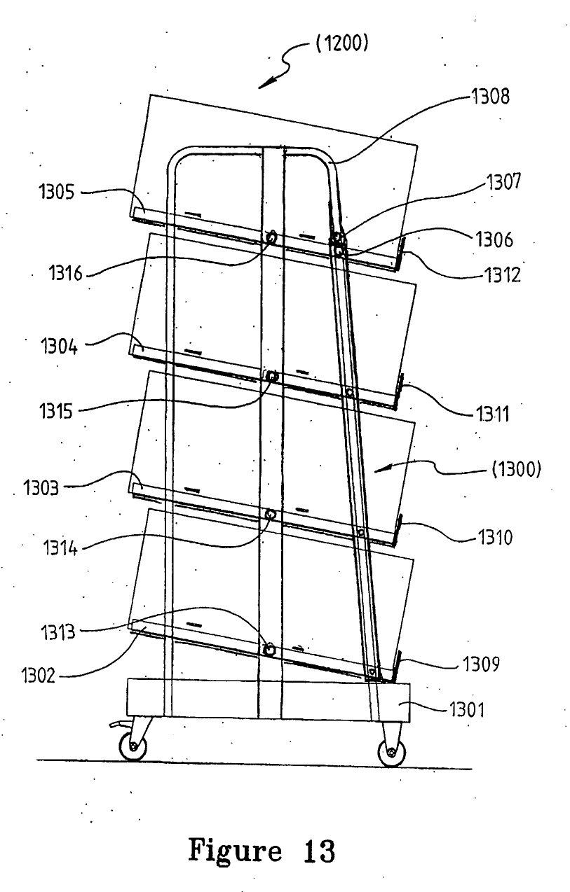

FIG. 13, illustrates a carton (1200) on a roll-in dolly (1300) of the same invention with a first horizontal spaced apart member 1301 and four multiple spaced apart members 1302, 1303, 1304 and 1305 on pivot points 1313, 1314, 1315, 1316 to angle the above spaced apart members to the gravity feed position when pin 1306 is released from slot 1307 in side upright frame 1308.

The front of each spaced apart horizontal member is dissected by a horizontal front member 1309, 1310, 1311 and 1312.

1-2. (canceled)

3. A stackable unit for transport and merchandising of articles, including:
a base, and a pair of spaced-apart side walls, the walls defining an open top of the unit to provide access to articles within the unit;
wherein the unit further includes stacking and nesting means which enable stacking of the unit on top of a lower adjacent like unit when in a first configuration, and nesting of the unit within a lower adjacent like unit when in a second configuration; and
wherein in order to move the unit from the second nested configuration to the first stacked configuration, the upper unit is stepped-back with respect to the lower unit, and vice versa.

4. A stackable unit according to claim 3, wherein the stacking and nesting means includes a series of alternating vertical tapered recesses and flutes formed in each of the side walls, the flutes being formed with enclosed bases, such that in the first configuration the base of each flute of the unit rests on a horizontal support of a lower adjacent like unit, and in the second configuration the flutes of the unit engage corresponding recesses of a lower adjacent like unit and thereby nests within the lower unit.

5. A stackable unit according to claim 4, wherein the spaced-apart side walls are tapered, being wider at their top then at their base to assist in nesting a plurality of the units.

6. A stackable unit according to claim 5, wherein the unit further includes rear and/or front horizontal members to assist in retaining articles within the unit during transport.

7. A stackable unit according to claim 4, wherein the unit is a crate, tray, or carton.

8. A stackable unit according to claim 4, wherein the unit is used to transport and merchandise articles including milk or other drink containers.

9. A stackable unit according to claim 3, wherein the spaced-apart side walls are tapered, being wider at their top then at their base to assist in nesting a plurality of the units.

10. A stackable unit according to claim 3, wherein the unit further includes rear and/or front horizontal members to assist in retaining articles within the unit during transport.

11. A stackable unit according to claim 4, wherein the unit further includes rear and/or front horizontal members to assist in retaining articles within the unit during transport.

12. A stackable unit according to claim 3, wherein the unit is a crate, tray, or carton.

13. A stackable unit according to claim 3, wherein the unit is used to transport and merchandise articles including milk or other drink containers.

14. A stackable unit according to claim 5, wherein the unit is a crate, tray, or carton.

15. A stackable unit according to claim 5, wherein the unit is used to transport and merchandise articles including milk or other drink containers.
